(19) United States
(12) Patent Application Publication
(10) Pub. No.: US 2017/0295817 A1
(43) Pub. Date: Oct. 19, 2017

(54) COMPOSITION FOR PRODUCING CHEWING GUM PRODUCTS

(71) Applicant: WUG FUNCTIONAL GUMS, S.L, CORDOBA (ES)

(72) Inventors: JOSE LUIS ROJANO JORGE, DONA MENCIA (ES); JORDI CLARAMONTE CALLEJON, DONA MENCIA (ES)

(73) Assignee: WUG FUNCTIONAL GUMS, S.L., CORDOBA (ES)

(21) Appl. No.: 15/518,420

(22) PCT Filed: Apr. 7, 2015
(86) PCT No.: PCT/ES2015/070271

§ 371 Date: Apr. 11, 2017

(30) Foreign Application Priority Data
Jan. 29, 2015 (ES) P201530112

(51) Int. Cl. A23G 4/14; A23G 4/06

(52) U.S. Cl. CPC A23G 4/14; A23G 4/068

(57) ABSTRACT

COMPOSITION FOR PRODUCING CHEWING GUM with relaxing properties, which, apart from chewing gum made with polyvinyl acetate, xanthan gum or Sapodilla tree sap, also contains at least tryptophan and optionally also melatonin and/or lemon balm and/or valerian in which the preferred embodiment includes the following ingredients in the indicated proportions:

| | |
|---|---|
| Tryptophan | 3.3333% |
| Melatonin | 0.0667% |
| Lemon balm | 1.6667% |
| Valerian | 6.6667% |
| Spearmint aroma | 2% |
| Absorcyl | 0.5% |
| Magnesium stearate | 2% |
| Magnesium oxide | 6.25% |
| Powdered stevia | 0.3333% |
| Chewing gum | 77.183% |

### OBJECT OF THE INVENTION

As set out in the title of this descriptive report, the invention refers to a composition for producing chewing gum with a series of characteristics that make it unique in the market.

More specifically, the object of the invention is a composition for producing chewing gum with relaxing properties.

### FIELD OF THE INVENTION

The field of the present invention is the food industry and in particular, the food supplements market. It also includes the OTC product and confectionery sectors and more specifically, the chewing gum sector.

### BACKGROUND OF THE INVENTION

In reference to the current state of the art, it should be mentioned that although an infinite number of compositions exist for producing chewing gum that include multiple varieties and flavours, the applicant, at least, is not aware of the existence of any that present the composition described and claimed herein.

INVENTION DISCLOSURE

In particular, the present invention refers to a composition for producing chewing gum with relaxing properties, in which, apart from the gum or chewing gum base, made with polyvinyl acetate, xanthan gum or with Sapodilla tree sap, it also includes at least a certain quantity of the hormone tryptophan. This hormone has a tranquilising effect and is known to be an essential amino acid and a precursor of serotonin, which in turn is a precursor of melatonin.

Optionally however, the described composition may also include certain significant quantities of melatonin, lemon balm and valerian and any combination of these ingredients.

It is a well-known fact that tryptophan is an essential amino acid in human nutrition that is vital in promoting the release of the neurotransmitter serotonin, which plays a part in sleep and pleasure regulation. For this reason, tryptophan helps to improve anxiety, insomnia and stress.

Tryptophan has the following properties, among others. As an essential amino acid, it helps the body elaborate its own proteins, it is essential for the pineal gland to segregate melatonin and it is a cerebral hormone that promotes sleep, for serotonin is a precursor of the hormone melatonin, a vital element in regulating the daily cycle of sleep and wakefulness.

Melatonin is a hormone segregated naturally by the body to regular the biological clock and daily cycle of sleep and wakefulness.

The hormone melatonin is found in higher animals and in some algae in concentrations that vary in accordance with the day/night cycle. Melatonin synthesis commences with the uptake of the essential amino acid tryptophan. This occurs mainly in the pineal gland and is involved in a large number of cellular, neuroendocrine and neurophysiological processes. One of the most significant characteristics of the pineal biosynthesis of melatonin is its variability during the 24-hour cycle and its precise response to changes in environmental light. For this reason melatonin is considered to be a neurohormone produced by the pinealocytes in the pineal gland (located in the diencephalon). It produces the hormone under the influence of the suprachiasmatic nucleus of the hypothalamus, which receives information from the retina on the daylight and darkness patterns.

For its part, lemon balm is a plant with sedative and tranquilising effects. More specifically, sweet balm, balm mint, citronella or lemon grass1 (Melissa officinalis) is a perennial herbaceous plant from the Mint family, native to southern Europe and the Mediterranean region. The plant is popular due to its strong lemon scent and is often used in infusions as a natural tranquiliser. The essential oil of this plant is used in the perfume industry.

Lastly, valerian is a plant that helps induce sleep, relaxing the nervous system and muscles. It helps reduce anxiety and psychological stress. Valeriana officinalis or common valerian and medicinal valerian is a perennial herbaceous plant from the ancient family Valerianaceae, now the subfamily Valerianoideae. It now belongs to the Caprifoliaceae family.

Valerian is one of the most relevant medicinal plants used for the nervous system. It is often used as a sedative and tranquiliser for hysteria, neurasthenia (insomnia, neurosis, abdominal cramps (colic), hyperexcitability, etc.), in menopausal disorders and as an antispasmodic in the widest sense. In addition, Valerian is used in seizure disorders with good results, alone or in combination with anticonvulsive drugs.

Based on the above, the main advantage lies in the administration of these four active ingredients in the form of chewing gum. The chewing action produces an instantaneous effect due to its assimilation by the oral mucosa, similar to a sublingual dose, unlike other products on the market (capsules, pills, teas, etc.) that que require digestion, leading to an assimilation time of between 30 and 40 minutes.

What is more, the described composition may also contain any one, various or all of the following ingredients:
Spearmint aroma
Absorcyl
Magnesium stearate
Magnesium oxide
Powdered stevia

Thus to produce the chewing gum with relaxing effects described in the invention, the preferred composition is formed by the following ingredients in the indicated proportions:

| | |
|---|---|
| Tryptophan | 3.3333% |
| Melatonin | 0.0667% |
| Lemon balm | 1.6667% |
| Valerian | 6.6667% |
| Spearmint aroma | 2% |
| Absorcyl | 0.5% |
| Magnesium stearate | 2% |
| Magnesium oxide | 6.25% |
| Powdered stevia | 0.3333% |
| Chewing gum | 77.183% |

Lastly, and in order to be more specific, the preferred embodiment of the composition to produce a piece of chewing gum includes a variable amount of chewing gum of between 1 g and 1.5 g, and the following ingredients, in the indicated quantities:

| | |
|---|---|
| Tryptophan | 50 mg |
| Melatonin | 1 mg |
| Lemon balm | 25 mg |
| Valerian | 100 mg |
| Spearmint aroma | 30 mg |
| Absorcyl | 7.5 mg |
| Magnesium stearate | 30 mg |
| Magnesium oxide | 93.75 mg |
| Powdered stevia | 5 mg |

Having described in sufficient detail the nature of this invention and the way it is put into practice, it is not considered necessary to go into further length about its disclosure to allow an expert in the matter to understand its scope and the advantages it brings. It is hereby stated that based on its essential characteristics, it can be put into practice in other forms of elaboration that differ in detail from that indicated as an example, which will also be included in the protection sought, provided its fundamental principle is not altered, changed or modified.

1. A Composition for Producing Chewing Gum that chewing gum and is made with polyvinyl acetate, xanthan gum or Sapodilla tree sap, wherein the composition also contains tryptophan.

2. The Composition for Producing Chewing Gum as set out in claim 1, wherein the composition also contains melatonin.

3. The Composition for Producing Chewing Gum as set out in claim 1, wherein the composition also contains lemon balm.

4. The Composition for Producing Chewing Gum as set out in claim 1 wherein the composition also contains valerian.

5. Composition for Producing Chewing Gum as set out in claim 1 wherein the composition contains the following ingredients, in the indicated proportions:

| | |
|---|---|
| Tryptophan | 3.3333% |
| Melatonin | 0.0667% |
| Lemon balm | 1.6667% |
| Valerian | 6.6667% |
| Spearmint aroma | 2% |
| Absorcyl | 0.5% |
| Magnesium stearate | 2% |
| Magnesium oxide | 6.25% |
| Powdered stevia | 0.3333% |
| Chewing gum | 77.183% |

6. The Composition for Producing Chewing Gum as set out in claim 5, wherein to produce a piece of gum, a variable amount of chewing gum is required of between 1 g and 1.5 g, and the following ingredients, in the indicated quantities:

| | |
|---|---|
| Tryptophan | 50 mg |
| Melatonin | 1 mg |
| Lemon balm | 25 mg |
| Valerian | 100 mg |
| Spearmint aroma | 30 mg |
| Absorcyl | 7.5 mg |
| Magnesium stearate | 30 mg |
| Magnesium oxide | 93.75 mg |
| Powdered stevia | 5 mg, |
